(19) United States
(12) Patent Application Publication
(10) Pub. No.: US 2017/0054982 A1
(43) Pub. Date: Feb. 23, 2017

(54) REAL TIME VIDEO STREAM PROCESSING SYSTEMS AND METHODS THEREOF

(71) Applicant: Hitachi, Ltd., Tokyo (JP)

(72) Inventors: Rajesh VELLORE ARUMUGAM, Singapore (SG); Wujuan LIN, Singapore (SG); Abeykoon Mudiyanselage Hunfuko Asanka ABEYKOON, Singapore (SG); Weixiang GOH, Singapore (SG)

(21) Appl. No.: 14/830,242

(22) Filed: Aug. 19, 2015

(51) Int. Cl. H04N 19/132; H04N 19/172; H04N 19/61; G06T 1/20

(52) U.S. Cl. CPC H04N 19/132; G06T 1/20; H04N 19/172; H04N 19/61

(57) ABSTRACT

Real-time image processing and annotation of video streams is provided by a system of plural processors and memory storing executable instructions to cause the processors to execute real-time processing. Different regions are set for frames of the video stream which define objects therein based on the context or content thereof. Skipping intervals are set for each region. Frames are individually selected from the video stream according to each skipping interval of each region. Specific regions are separately processed by different processors in the selected frames which are separated at intervals within the video stream by the frame skipping values. The processing of the regions identifies objects therein and stores descriptions of the objects in an index to facilitate searching of the video content. The activity of the objects in the video stream further cause the frame skipping levels to change thereby causing selected individual frames to be dynamically processed.

### FIELD OF INVENTION

The present invention relates to processing video streams, and, more specifically, to a processing architecture in which video stream processing is managed to reduce processing load and time.

### BACKGROUND

The Communications, Media and Entertainment (CME) industries generate large volumes of digital content. Generally, the digital content takes the form of video files that require processing to extract content-based metadata to facilitate annotation, indexing and searching by various users. Video files are typically stored and managed in media asset management (MAM) systems which provide interfaces for users to annotate and search the content. However, the manual analysis of the video data stored in a MAM becomes impractical as the volume of the digital content grows. In many instances, the time required for the manual analysis of video data is several times greater than the length of the video data itself. To address this issue, conventional systems have been developed which attempt to automate the analysis process using complex image processing algorithms on the digital content. Image processing algorithms are able to automatically identify everyday objects, shapes, and people in the video frames and automatically annotate the video files based on the identification. Software applications apply image processing algorithms to automatically analyze video streams, attempting to recognize certain features of interest therein relating to particular types of content present in the streams. For example, algorithms and applications are known in the art for recognizing and identifying faces, gestures, vehicles, motions, objects and the like within digital content.

As such, in addition to automating the analysis of video data with the implementation of image processing algorithms, there is also a need for the analysis to be performed in real time due to the increasing volume of digital content and increasing rate of consumption thereof from the increased usage of broadcasting and media applications. However, numerous challenges exist in performing object detection and face identification processing in real-time due to the high computational resource requirements of image processing algorithms which have been used in conventional systems.

For example, object detection and face identification processing requires complex mathematical operations on pixel values of individual video frames to extract features and further match extracted features with a feature database. Such processing operations generally incur high computational overhead, and hence, it is difficult to perform object detection and face identification in real time to the individual frames which comprise streaming video. While a degree of rudimentary analysis, such as general motion detection and gross object detection, can typically be performed quickly and in real-time, more complex analysis of a video stream requires additional time to complete the processing thereby sacrificing the ability to perform real-time processing. While distributed and parallel architectures have been conventionally proposed in the past in attempt to address these issues, difficulties are still present and conventional systems remain imperfect in achieving the foregoing objective of real-time processing.

One need for MAM systems is to identify specific objects and faces in video data, annotate and index terms describing the identified objects and people to facilitate future searches by end users. The identification of specific objects and faces for purposes of annotation and indexing does not require detailed frame-by-frame processing to track such objects. In other words, objects need only be identified in the frames and do not need detailed frame-by-frame processing even though the object could be moving in successive frames. This allows for processing to exploit frame skipping in the video stream to improve the overall real-time processing performance.

As an example, U.S. Pat. No. 7,697,026 describes a method of analyzing multiple video streams based on frame skipping where multi-stage video frame processing is proposed which requires increasing levels of computational overhead from low end gross feature extraction to complex identification of objects/events within a frame. In this conventional system, a quick frame processing-stage determines whether a frame needs to be processed in successive, more complex processing stages based on motion detection or other gross object detection. For example, the quick frame processing-stage allows skipping of frames based on the absence of motion being detected in the frame. The problem inherent in such an approach is that even when there are minor changes in the frames, like object movement or changes in object orientation, each frame will still be processed which might not be necessary as the objects generally remain the same from a previous frame. Further, U.S. Pat. Nos. 7,606,391 and 7,667,732 are similar in using gross feature extraction, motion detection or histogram computation to detect changes in frames to decide whether to perform skip processing.

As another example, U.S. Pat. No. 6,731,813 describes a method of adapting frame intervals for compression. Differences in successive video frames are used to determine a skipping interval. However, the differences are based on motion detection computed over the entirety of individual whole frames. Such an approach has similar problems to the conventional techniques explained above. In addition, minor changes in object orientations or local movements in each frame are detected, causing the frames to be processed unnecessarily. The result is the unnecessary processing of redundant frames that may be avoided. In other words, minor changes in successive frames are falsely detected and cause the frames to be processed. In practice, this causes a large number of frames to undergo more computationally-intensive processing, which is a significant drawback to the overall processing efficiency, which includes processing time and processing load, when attempting to realize real-time processing.

Therefore, a need exists for a video stream processing scheme that employ identification and extraction of video streams to accurately and efficiently facilitate annotation and indexing of the video streams, while reducing the computation overhead and unnecessary frame processing associated with conventional systems. The present invention fulfills these needs as well as others, while realizing improved real-time processing of video streams.

### BRIEF SUMMARY

The present invention comprises methods and systems which utilize region-based frame skipping. When identifying objects and people from video streams to facilitate accurate indexing and searching of digital content, region-based frame skipping exploits the fact that objects do not require detailed tracking while the accurate identification of faces is of greater importance. Accordingly, the need for detailed processing of each individual successive frame in the video stream can be avoided. Accordingly, techniques are herein described provide processing methods for a video stream in real-time by skipping frames of the video stream based on detected activity in different frame regions of interest identified in the given video stream. Further, the processing methods can be applied to multiple video streams in real-time as well. The skipping of frames occur at skipping intervals representing the number of frames within a video stream which are to be skipped or omitted from processing, and the skipping intervals are separately determined based on the activity of the objects detected within the separately identified regions of the video stream. Each region will have different skipping intervals based on the object activity within the respective region. This can advantageously provide for the effective reduction in the processing overhead required to identify and annotate a video stream by skipping more frames without suffering from any loss in detection accuracy while also exploiting the processing advantages inherent in both distributed and parallel processing architectures. As a result, more digital content can be indexed for searching more efficiently within a shorter time and with reduced processing overhead than with conventional techniques.

In addition, the frame skipping interval can be manipulated based on recent search queries to provide still further improvements in processing efficiency. For example, regions containing objects that match popular search terms will be processed according to larger skip intervals thereby further reducing the processing overhead. Further, the frame processing is spread across multiple nodes with each region processed separately in parallel. The processing efficiency can also be improved by dynamically allocating processing resources to separate regions in a video stream or to separate video streams themselves according to the detected activity therein. For example, when more activity is detected, the respective skipping intervals will be reduced and the associated processing load will increase. In turn, more processing resources will be allocated to handle the processing of the regions or streams where the skipping intervals are short.

Another part of the present invention allocates resources to different video streams based on more number of regions or more activity. Video streams with more activity will have lesser skip intervals and needs more resources. Similarly streams with more regions require more resources for their processing. Processing resources are allocated accordingly based on this.

By way of example, and not of limitation, one implementation includes a method for processing a video stream which includes setting a plurality of regions, including a first region and a second region, in the video stream, and setting a plurality of frame skip values for the regions, including a first frame skip value for the first region and a second frame skip value for the second region, according to respective contexts thereof. Each of the regions is analyzed in a plurality of frames of the video stream with a plurality of processors, including a first processor and a second processor, such that the first region is analyzed by the first processor and the second region is analyzed by the second processor. In some implementations, the regions may be updated at predetermined intervals.

The analysis of the first region by the first processor includes analyzing the first region in a first frame of the video stream, selecting a second frame of the video stream according to the first frame skip value, analyzing the first region in the second frame, and updating the first frame skip value based on activity in the first region. Further, the analyzing of the second region by the second processor includes analyzing the second region in a third frame of the video stream, selecting a fourth frame of the video stream according to the second frame skip value, analyzing the second region in the fourth frame, and updating the second frame skip value based on activity in the second region.

In further implementations, the first frame skip value for the first region is set according to a first object therein, the second frame skip value for the second region is set according to a second object therein different from the first object, and the first frame skip value and the second frame skip value are different. In addition, the first processor analyzes the first object in the first region and the activity in the first region is based on analyzing the first object, while the second processor analyzes the second object in the second region and the activity in the second region is based on analyzing the second object. In some instances the activity being analyzed is zooming in or out on the particular object or detecting the movement of the particular object.

In other implementations, when the activity in the first region is greater than an activity threshold, one or more additional processors are allocated to analyze the first region. Similarly, when a number of the regions is greater than a region threshold, one or more additional processors are allocated to analyze the regions.

In yet other implementations, a third processor of the plurality of processors sets the plurality of regions, and each of the regions in the video stream, including the first region and the second region, are separately processed on different ones of the processors other than the third processor.

In still further implementations, the frame skip values are adjustable. For example, the first processor decreases the first frame skip value when the first processor detects that the activity from the first frame to the second frame is greater than a threshold. In addition, the first processor increases the first frame skip value when the first processor detects that the activity from the first frame to the second frame is less than the threshold. Likewise, the second processor may respectively perform similar processing.

In yet other implementations, a search history of previously indexed search terms is stored in a computer-readable medium. When the plurality of regions are set, these regions, which include the first region and the second region, are analyzed to determine whether any objects are present therein that match the search history. When an object matching the search history is present in the first region, the first frame skip value is increased prior to analyzing the first region by the first processor. Likewise, when an object matching the search history is present in the second region, the second frame skip value is increased prior to analyzing the second region by the second processor.

Further, other features and advantages will become apparent to those skilled in the art from the following detailed description in which various implementations of the present invention are shown and described by way of example. As will be appreciated, the implementations described herein are capable of modification in various respects, all without departing from the scope of the present invention. Accordingly, the drawings and detailed description as set forth below are to be regarded as illustrative in nature and not as restrictive.

### BRIEF DESCRIPTION OF THE DRAWINGS

The detailed description is set forth with reference to the accompanying figures. In the figures, use of the same reference numbers in different figures indicates similar or identical items or features.

FIG. 1 illustrates an example real-time video stream processing system for a video stream according to some implementations.

FIG. 2 illustrates an example video segment analyzer of a processing system according to some implementations.

FIG. 3 illustrates a frame skipping table managed by a video segment analyzer according to some implementations.

FIG. 4 illustrates an example video frame allocator of a processing system according to some implementations.

FIG. 5 illustrates a frame allocation table managed by a video frame allocator according to some implementations.

FIG. 6 illustrates an example video frame region processor of a processing system according to some implementations.

FIG. 7 illustrates a region activity table managed by a video frame region processor according to some implementations.

FIG. 8 illustrates another example of a real-time video stream processing system according to some implementations.

FIG. 9 illustrates a video stream feature index according to some implementations.

FIG. 10 illustrates an example workflow in a processing system according to some implementations.

FIG. 11 illustrates an example process flow for determining frame skipping intervals and allocation of regions for processing.

FIG. 12 illustrates an example of a detailed workflow for processing a video stream in a processing system according to some implementations.

FIG. 13 illustrates an example region processing and frame skip interval updating flow according to some implementations.

FIG. 14 illustrates an example workflow for processing multiple video streams in a processing system according to some implementations.

FIG. 15 illustrates an example alternative workflow for determining frame skipping intervals according to some implementations.

FIG. 16 illustrates an example resource allocation workflow according to some implementations.

### DETAILED DESCRIPTION

In the following detailed description, various details are set forth in order to provide a thorough understanding of various implementations of the present invention. However, it will be apparent to those of skill in the art that these specific details may not all be needed to practice the present invention. As those of skill in the art will understand, well-known structures, materials, circuits, image processing algorithms and processes have not been described in detail, and/or may be illustrated in block diagram form, so as to not unnecessarily obscure the explanation of the present invention.

Furthermore, some portions of the detailed description that follow are presented in terms of algorithms or processes and symbolic representations of operations within a computer. These algorithmic descriptions and symbolic representations are the means used by those skilled in the data processing arts to most effectively convey the essence of their innovations to others skilled in the art. An algorithm or process is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “analysing,” “extracting,” or the like, can include the actions and processes of a computer system or other information processing device that manipulates and transforms data, such as streaming video data, represented as physical (electronic) quantities within the computer system's registers and memories into other data similarly represented as physical quantities within the computer system's memories or registers or other information storage, transmission or display devices.

Some implementations relate to an apparatus (one or more apparatuses) for performing the operations herein. The apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. The operations described in flowcharts, for example, may be executed by one or more processing devices, e.g., central processing units (CPUs), processors, or similar computing devices as will become apparent to those of skill in the art.

Some of the figures are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, systems and devices described in the examples herein, although the processes may be implemented in a wide variety of other environments, systems and devices. Although the various types of data may be described as being stored in tables, buffers or memory in general, the data may be stored in other appropriate data structures and apparatuses such as cache memory, random access memory, flash memory, hard disk drives and other similar storage devices.

The various implementations described herein provide technological innovations for video stream processing in which a video stream which is made of a plurality of frames is received and processed in a manner to reduce processing overhead by utilizing one or more of periodic analysis of the video stream, partial analysis of frames by region, varying the analysis frequency, and providing multiple processing units. In some examples, a segment of a first video stream is analyzed by a video segment analyzer to determine whether any matching search context is present therein, such as content metadata information to be annotated to the first video stream, and frame skip values are set for particular regions of interest in the first video stream segment. Frames of the first video stream are then allocated to processing nodes by a video frame allocator according to the regions of interest and the frame skip values. Individual video frame region processors then perform analysis on the particular regions of interest separately, and based on activity detected therein update the frame skip value(s). In addition, after a predetermined period has elapsed, another segment of the first video stream is analyzed by the video segment analyzer to again determine whether any matching search context is present therein, update the particular regions of interest in the first video stream segment and update the frame skip values for the updated regions of interest. Meanwhile, other video streams may be processed similarly to the first video stream while processing of the first video stream is ongoing. The technology herein thus allows for one or more video streams to be processed to annotate content-based metadata to the video streams in real-time.

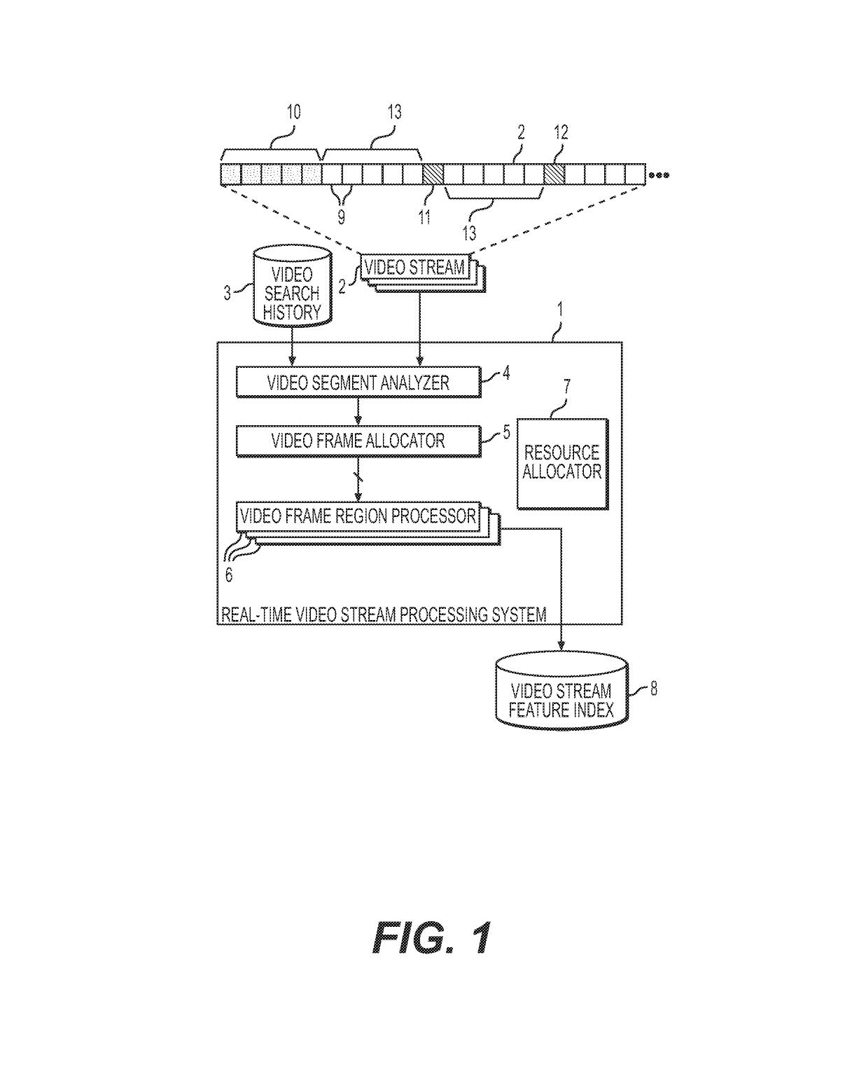

As one example, FIG. 1 shows a real-time video stream processing system 1 having a configuration which includes a video segment analyzer 4, a video frame allocator 5 and video frame region processors 6, which are provided in plural as a processing cluster of nodes, which are involved in the processing of one or more video streams 2 with respect to a video search history 3 which is a collection of search queries which is applied to processing relating to annotation of the video streams 2. The video search history 3 may be based upon recent or popular search queries, for example. The video segment analyzer 4 is responsible for the sampling and initial analysis to extract feature vectors from the video streams 2 which are received by the real-time video stream processing system 1. The description herein generally describes the processing and analysis related to one video stream for simplicity. However, the processing of additional video streams can be facilitated with similar processing and analysis as will be understood based on the description herein.

For a given one of the video streams 2, the video stream 2 is composed of a plurality of individual frames 9 as shown in FIG. 1. The video segment analyzer 4 first samples a segment 10 which is a subset of frames 9 from the video stream, and performs an initial analysis on the segment 10 of the video stream, which is made of plural frames 9, to set regions which are specific areas existing in the frames 9 which are to be processed by the video frame region processors 6. The video segment analyzer 4 also performs the initial analysis to determine region activity in the regions set for the segment 10. In the initial analysis, the whole frames of the segment of the video stream are analyzed to detect objects of interest to set regions therein according to the detected objects. Accordingly, each region set by the video segment analyzer will include a particular object of interest therein which will be processed and tracked by the real-time video stream processing system 1.

In some implementations, the video segment analyzer 4 also refers the video search history 3 to determine whether any matches between the terms in the video search history 3 and the visual content contained in the regions in the segment 10 of the video stream 2. Based on video frame region activity and further any video search history matches, the video segment analyzer 4 determines individual frame skip values for each of the regions. The frame skip values represent intervals 13 of frames for which processing can be skipped, omitted or otherwise disregarded without the risk of losing information on the objects in the regions. The video segment analyzer 4 determines a single frame skip value for each respective region which can vary dynamically as will described later. As such, each region set by the video segment analyzer 4 has a respective frame skip value which may be the same as or different from frame skip values for other regions of the video stream 2.

The video frame allocator 5 assigns video frames 9 of the video stream 2 to the plurality of video frame region processors 6 for further processing based on the frame skip intervals and the available resources of the video processing system. Each region set by the video segment analyzer 4 is assigned to one of the video frame region processors 6, and the video frame allocator 5 will assign individual video frames 9 selected from the video stream 2 to the video frame region processors according to the respective frame skip values. Each region in an assigned frame 11, 12 is processed by one of the video frame region processors 6 to determine activity of a particular object of interest therein. For example, the objects of interest may be persons or objects such as cars, trees, and the like. While each one of the video frame region processors 6 may receive frames 9 from the video frame allocator 5 for more than one region in the video stream 2, in general, each region in the video stream 2 is not processed by more than one of the video frame region processors 6.

The video processing system shown in FIG. 1 also includes a resource allocator 7 to manage the allocation of computational resources to the video frame region processors 6 based on the number of regions set for the video stream and region activity levels as determined by the video segment analyzer 4 and video frame region processors 5. According to the analysis of the regions by the video frame region processors 6, features of the objects within the regions are identified and descriptors thereof are stored in a video frame features index 8. The video frame features index 8 may be configured as a database of descriptors of objects identified in the video streams 2 to facilitate searching of the content of the video streams 2. The particular components of the real-time video stream processing system 1 in FIG. 1 are described in further detail below.

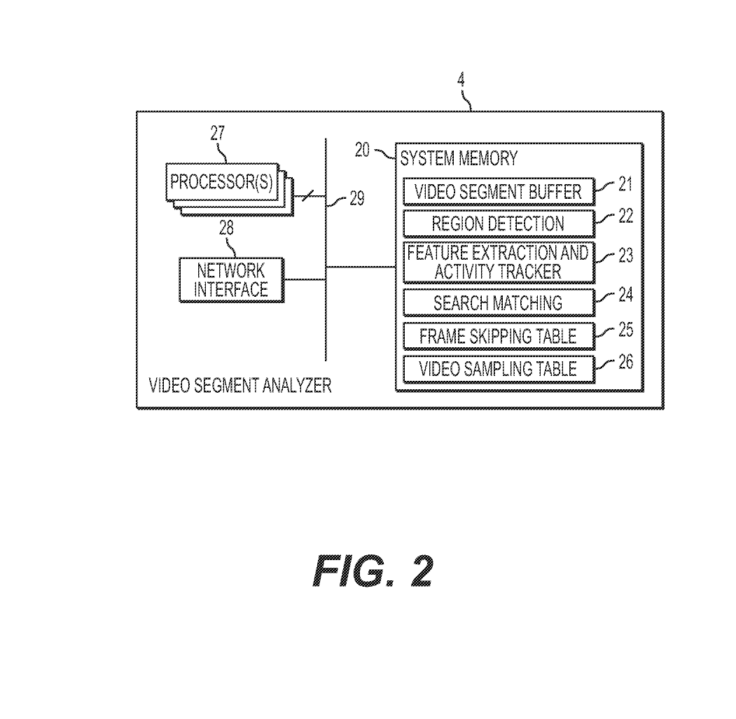

FIG. 2 illustrates an example video segment analyzer 4 according to some implementations. The video segment analyzer 4 includes a system memory 20, at least one processor 27, a network interface 28 to facilitate communication and on which the video streams 2 are received, and a system bus 29 which connects the processor(s) 27, the network interface 28 and the system memory 20. The system memory 20 stores computer-readable data and executable instructions. As shown in FIG. 2, the system memory 20 includes a video segment frame buffer 21 containing sampled frames 9 of the video stream 2 which form the segment 10 of the video stream 2, and a region detection module 22 that includes image processing algorithms to identify and set regions and region boundaries thereof in the frames 9 of the segment 10. A feature extraction and activity tracker module 23 consists of image processing algorithms to extract features, in the form of feature vectors, for example, of the objects from the regions of the frames 9 in the video segment frame buffer 21 to detect objects such as shapes, faces, cars, building, orientations thereof, motion thereof and the like. A video search matching module 24 detects matches between the detected objects in the regions with terms from the video search history 3.

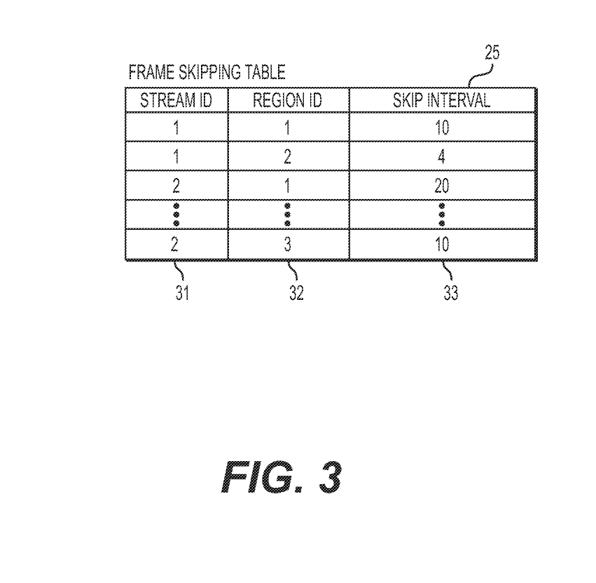

Based any matches from the search matching module 24, a frame skipping table 25 will be updated for each region by the feature extraction and activity tracker module 23 in accordance with respective levels of activity therein. As shown in FIG. 3, the frame skipping table 25 includes a stream identifier (Stream ID) 31 to identify the video stream 2, a region identifier (Region ID) 32 to identify the region within the associated video stream 2 and a frame skip value (Skip Interval) 33 for the associated region. Each region set for the video stream 2 will have a separate frame skip value 33, otherwise referred to herein as a skip interval. The frame skip values 33 identify how many contiguous frames 13 are skipped in the video stream 2 between frames 11, 12 which are processed by the video frame region processors 6. Thus, each of the frame skip values 33 defines an interval 13 in the video stream 2 at which non-sequential frames 11, 12 are selected for processing of a particular region contained therein based on the associations shown in in the frame skipping table 25. The information in the frame skipping table 25 stored in the system memory 20 of the video segment analyzer 4 is communicated, transferred, shared or otherwise made available to the Video Frame Allocator 5 and video frame region processors 6.

For example, in FIG. 3, for StreamID #1, there are two regions having RegionIDs #1 and #2. RegionID #1 has a skip interval value 33 corresponding to 10 frames 9 and RegionID #2 has a frame skip value 33 corresponding to 4 frames 9. Meanwhile, StreamID #2 has three different regions each with separately defined skip intervals 33. As such, for StreamID #1 and RegionID #1, sampling of the video stream 2 will skip frames 9 in intervals 13 of 10 frames during the processing of RegionID #1. Meanwhile, for StreamID #2 and RegionID #1, sampling of the video stream 2 will skip frames 9 in intervals 13 of 20 frames during the processing of RegionID #1 for StreamID#2.

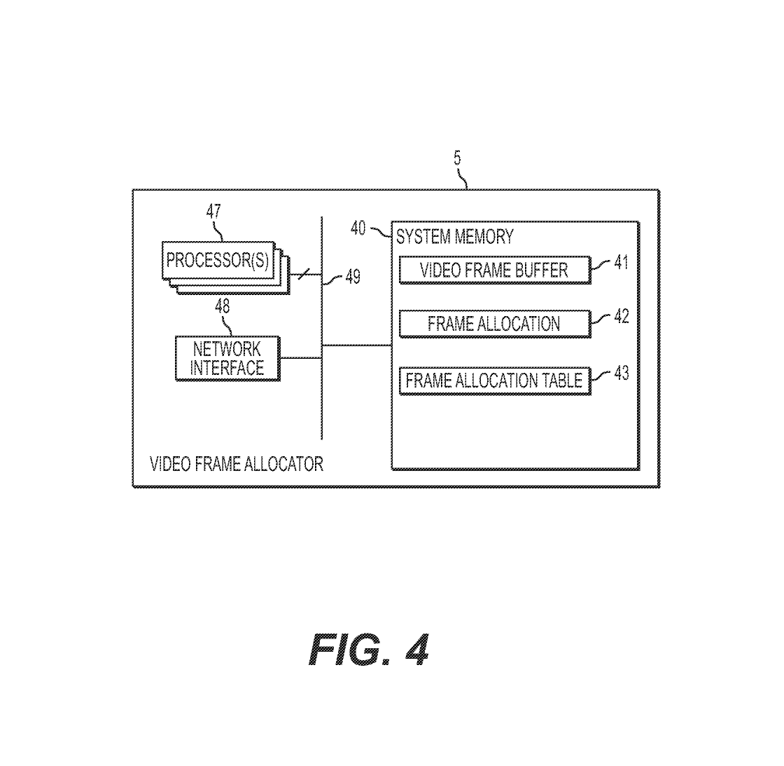

FIG. 4 illustrates an example video frame allocator 5 according to some implementations. The video frame allocator 5 includes a system memory 40, at least one processor 47, a network interface 48 on which the video streams 2 are received, and a system bus 49 which connects the processor(s) 47, the network interface 48 and the system memory 40.

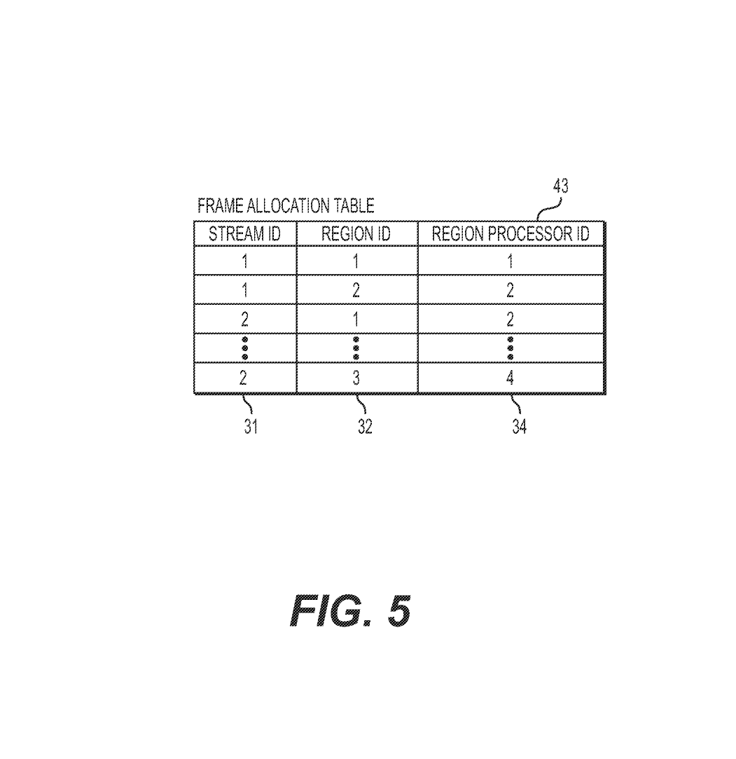

In the system memory 40, a video frame buffer 41 is provided to store video frames 11, 12 which are sampled or otherwise selected from the video stream 2 in accordance with the frame skipping table 25. Further, a video frame allocation module 42 determines which of the different video frame region processors 6 are assigned to process the different regions identified in the frame skipping table 25. The assignment of the video frame region processors 6 is maintained in a frame allocation table 43 in the system memory 40. FIG. 5 shows an example of the frame allocation table 43. As shown in FIG. 5, the frame allocation table 43 contains the mapping of the associated Stream IDs 31 and Region IDs 32 to the video frame region processors 6 by region processor identifiers (RegionProcessor ID) 34. The frame allocation table 43 is initially set for a new video stream and may be periodically updated thereafter. The frame allocation table 43 may also be updated whenever changes occur to the frame skipping table 25. Similar to the frame skipping table 25, the frame allocation table 43 stores Stream IDs 31, Region IDs 32 and RegionProcessor IDs 34 in association to track the assignment of the video frame region processors 6 to the processing of the regions of the video streams 2.

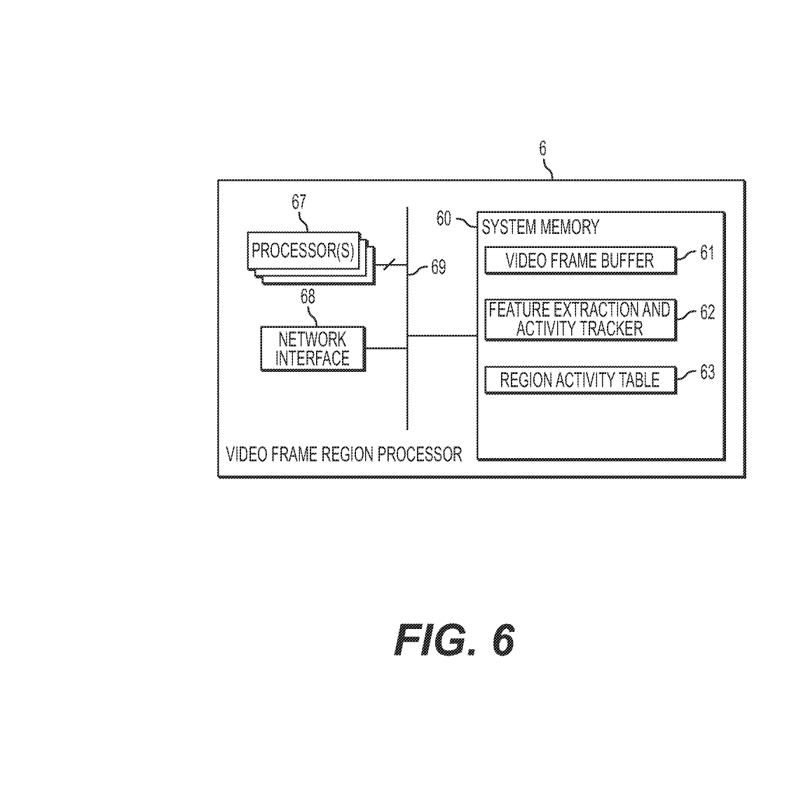

FIG. 6 illustrates an example video frame region processor 6 according to some implementations. The video frame region processors 6 in FIG. 6 includes a system memory 60, at least one processor 67, a network interface 68 on which frames of the video streams 2 are received, and a system bus 69 which connects the processor(s) 67, the network interface 68 and the system memory 60.

In the system memory 60, a video frame buffer 61 is provided to store frames 11, 12 received from the video frame allocator 5. Similar to the video segment analyzer 4, the video frame region processor 6 has a feature extraction and activity tracker module 62 which contains image processing algorithms for extracting features, in the form of feature vectors, for example, from objects in the respectively allocated region in the frames 11, 12 in the video frame buffer 61. The extracted features may include faces, objects and activity thereof like changes in shape, orientation or motion.

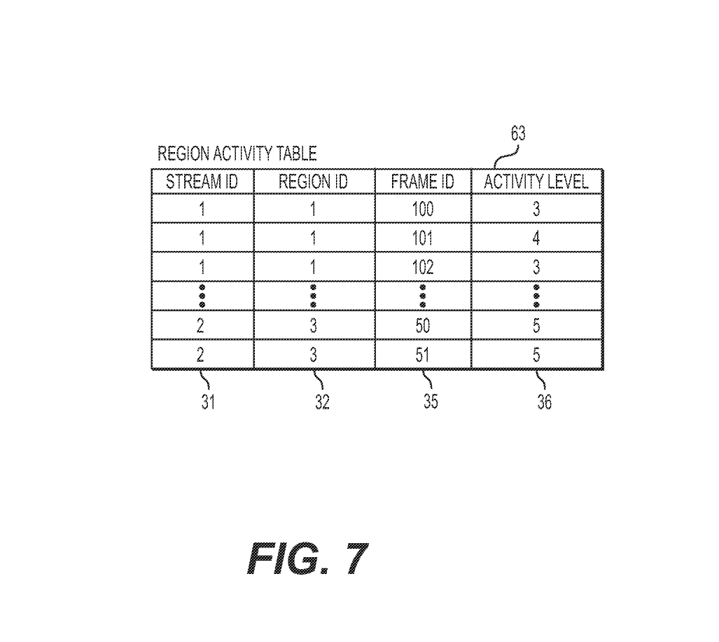

Based on the level of activity in the extracted features of the object in the region, the feature extraction and activity tracker module 62 updates a region activity table 63. The region activity table 63 stores the changes in activity level for the region according to each frame received and process from the video frame allocator 5. In other words, the history of object activity in the region processed by the respective video frame region processor 6 is maintained in the system memory 041. For example, FIG. 7 shows an example of the region activity table 63 managed by the video frame region processor 6. A frame identifier (Frame ID) 35 in the region activity table 63 tracks the frames 11, 12 of the video stream 2 while a region identifier (Region ID) 32 is provided to indicate which region of the video stream 2 is being processed. Increasing values of the Frame ID 35 in FIG. 7 indicate successively later frames in time of the video stream 2. An activity level 36 of the object in the processed region is recorded in the region activity table 63 and is updated for each frame that has been processed.

The feature extraction and activity tracking module 63 determines whether the frame skip value 33 corresponding to the Region ID 32 based on the activity level 36 of successively separated frames 11, 12. As shown in FIG. 7, for Frame ID #'s 100 to 102, changes in the activity level 36 for the same region (i.e., Region ID #1) in the stream 2 vary according to a predefined scale, such as from 0 to 10. In FIG. 7, the activity level 36 does not vary significantly indicating that the object of interest in the region is substantially static. As a result, the corresponding skip interval 33 will not be modified by the feature extraction and activity tracking module 63. In other cases, if the Activity level 36 increases by more than a predetermined threshold, the corresponding frame skip interval value 33 will be decreased. In contrast, in some cases, if the Activity level 36 decreases by more than the predetermined threshold, the corresponding frame skip interval value 33 will be increased. Such modification of the of the frame skip interval value 33 can update or refresh the interval 13 of frames 9 in the video stream 2 which will be skipped moving forwards by the video frame allocator 5.

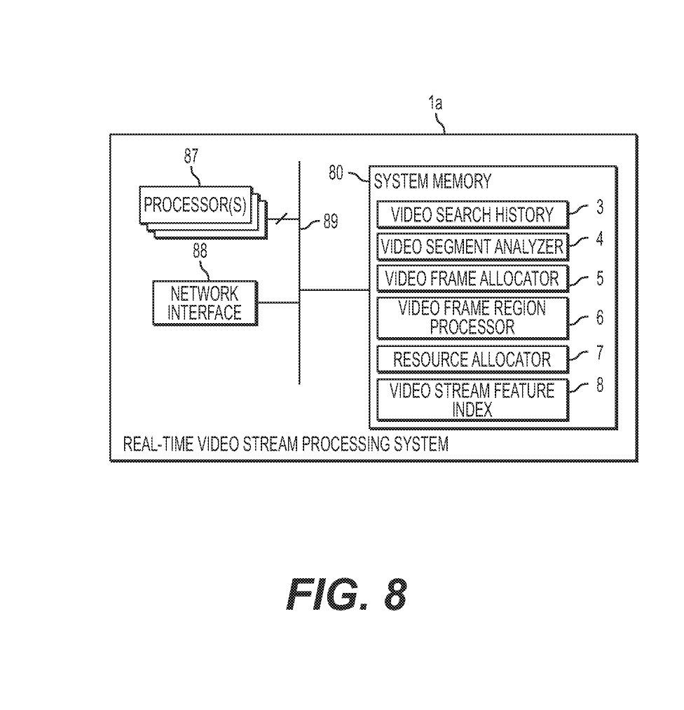

FIG. 8 illustrates another example of a real-time video stream processing system 1a according to some implementations. In FIG. 8, the video segment analyzer 4, video frame allocator 5, and video frame region processors 6 are provided in system memory 80 among the other features shown in FIG. 1. A plurality of processors 87 are provided together to execute and manage the contents of the system memory 80 while a network interface 88 and system bus 89 facilitate communication and reception of video streams 2. Accordingly, FIG. 8 provides an integrated implementation of the structures shown in FIGS. 2 through 7. Further, in such configurations, the processors 87 are separately configured to execute the contents of system memory 60 to realize individual video frame region processors 6 according to the number of regions set for each video stream as described herein.

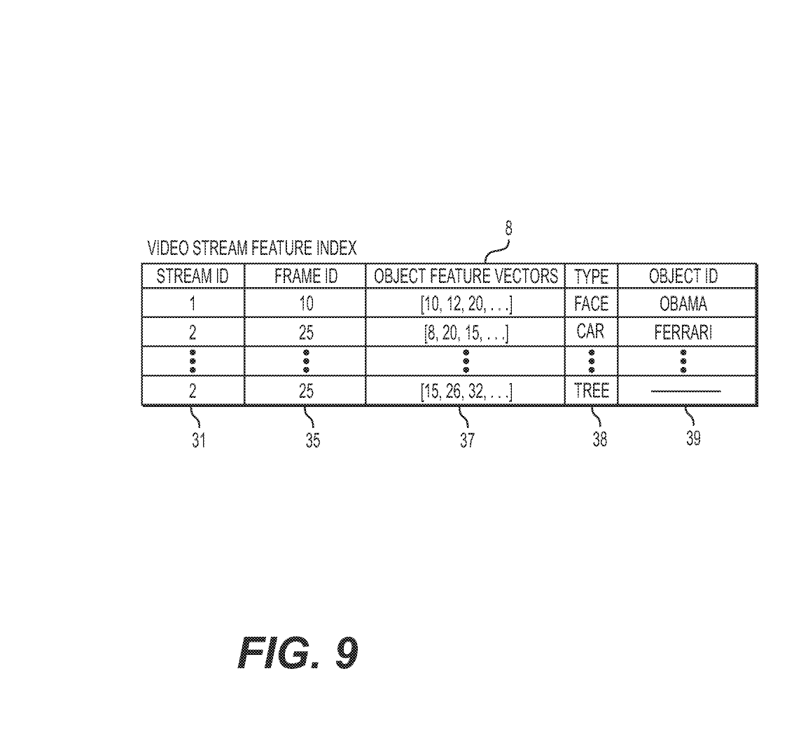

FIG. 9 illustrates a video stream feature index 8 according to some implementations. The video stream feature index stores data specific to describing the features extracted from the regions of each video stream by the video segment analyzer 4 and the video frame region processors 6 and the corresponding types and descriptions of the objects. For example, stream IDs 31, frame IDs 35, object feature vectors 37 which are values calculated by the image processing algorithms, object types 38, and one or more descriptors specific to the objects 39. In some implementations, the stream IDs 31 may be file names or the like while the frame IDs 35 may be frame numbers within the stream or the like to identify the logical location of the frame 9 in the video stream 2.

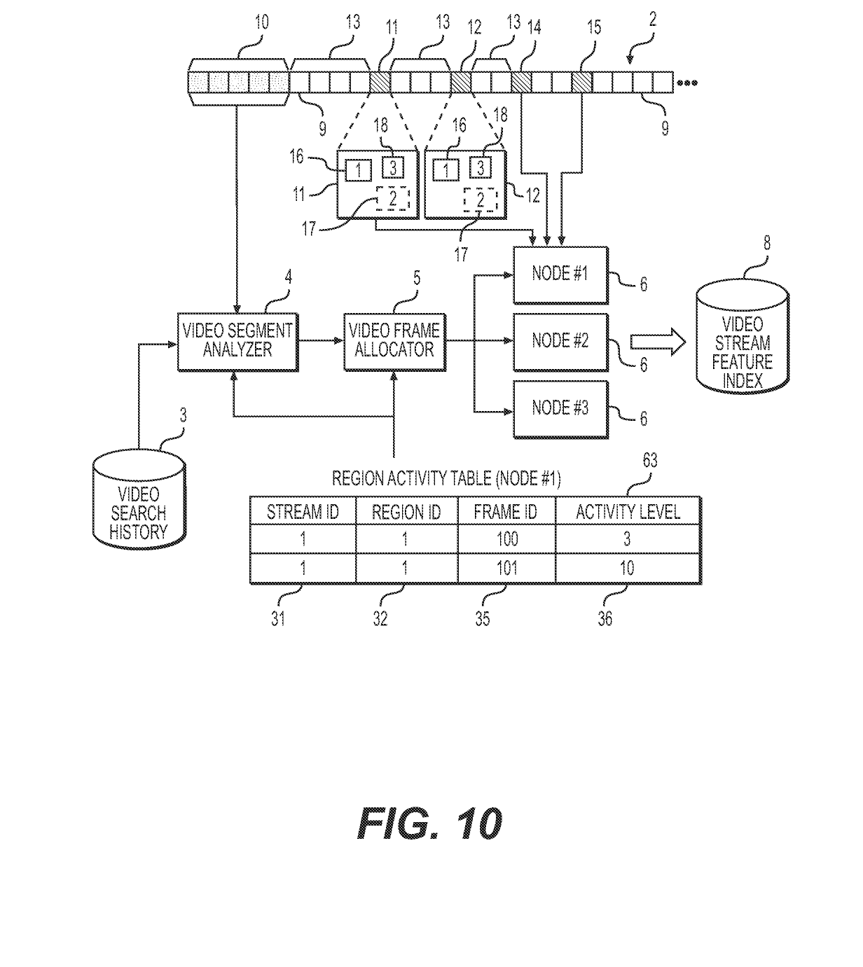

FIG. 10 illustrates an example workflow in an exemplary real-time video frame processing system implementation. In FIG. 10, the control flow among the system components is shown for processing a single video stream 2. However, multiple video streams may be processed in real-time simultaneously, and the singular video stream 2 is merely shown for purposes of explanation.

The video segment analyzer 4 receives a video search history 3 for reference during the processing of video streams. A video stream 2 is received for real-time processing by the video segment analyzer 4. The video stream 2 is made up of a plurality of frames similar to FIG. 1. The video segment analyzer 4 samples a segment 10 of the frames 9 from the video stream 2 and places the segment 10 in the video segment buffer 21. Then, the segment 10 is analyzed to set regions 16, 17, 18 therein by the region detection module 22. The region detection module 22 applies image processing algorithms to the frames of the segment 10 to identify regions 16, 17, 18 in the frames of the segment 10 containing particular objects of interest. For example, the analysis includes, but is not limited to, face detection and object detection. The video frame region detection module 22 further determines and sets the boundaries of the different regions 16, 17, 18 in the frames. In FIG. 10, for purposes of explanation, three regions are shown to be set in the frames 11, 12 of the video stream 2, however any number of regions may be set based in the visual content of the segment 10 of the video stream 2. After setting the regions 16, 17, 18, the feature extraction and activity tracker module 23 applies image processing algorithms to perform face identification and object identification, for example. In addition, any activity in the regions 16, 17, 18 in the frames of the segment 10 is determined by the feature extraction and activity tracker module 23. Activity in the regions is characterized, for example, as changes in shape, orientation, or motion of the objects therein. As a result, the feature extraction and activity tracker module 23 determines a skip interval value 33 for each of the regions 16, 17, 18 set by the video frame region detection module 22. The frame skip values are stored in the frame skipping table 25 as shown in FIG. 3, for example.

The video segment analyzer 4 may also determine the skip intervals 33 based on the results of the feature extraction and activity tracker module 23 matching with any of the terms included in the video search history 3. When a match is found to exist between terms of a search query and the description of an object in a region, the video segment analyzer 4 will increase the skip interval for the respective region in the video stream. While not shown, the resource allocator 7 may also be included in the real-time video processing system in FIG. 10. The resource allocator 7 allocates computational resources such as additional video frame region processors 6 to the video processing cluster based on the number of regions set therein by the video segment analyzer 4 and further based on the level of activity for each of the regions. For example, a video frame region processor 6 handling the processing of a region having relatively higher activity levels can receive additional computational resources from the resource allocator 7 in the form of additional processors or memory to compensate for the increased processing load which will be incurred since higher activity levels cause the skip interval 13 to be decreased.

In accordance with the skip interval values 33, the video frame allocator 5 determines the distribution of region processing among the video frame region processors 6. In other words, a video frame allocation module 42 determines which of the video frame region processors 6 are respectively assigned to process the different regions identified in the frame skipping table 25. As explained with respect to FIG. 1, the assignment of regions to the video frame region processors 6 is maintained in a frame allocation table 43 in the system memory 40 and is shown in FIG. 5, for example.

Three video frame region processors 6 are shown as a video processing cluster consisting of nodes #1, #2 and #3 in FIG. 10. In other words, the video processing cluster 115 is configured as three separate processing nodes which may each be configured similarly to FIG. 6. However, the multiple video frame region processors 6 may be configured as separate computers, CPUs, CPU cores within the same computer, processing threads or a combination thereof. Each video frame region processor 6 processes the particular frame region(s) allocated by the video frame allocator 5. Each of the video frame region processors performs feature extraction and activity tracking the individual regions assigned by the video frame allocator 5 using the feature extraction and activity tracker module. The activity of each assigned region 16, 17, 18 is tracked in the region activity table 136. The Activity level 139 is continuously updated for each region identified by the Region ID 32 on a frame-by-frame basis in accordance with the Frame ID 35 in the region activity table 63.

In frames 11 and 12 in FIG. 10, three regions 16, 17, and 18 are shown to be set from the segment 10. The processing for the three regions is respectively distributed to the three nodes #1 to #3 so that node #1 processes region 16 (i.e., region ID #1), node #2 processes region 17 (i.e., region ID #2) and node #3 processes region 18 (i.e., region ID #3). Further, according to the frame skipping table 25, node #1 is caused to process only the frames 11, 12, 14, 15 and so on in the video stream which are selected, for example, by the video frame allocator 5 by referring to the frame skipping table 25. Nodes #2 and #3 each process frames 9 selected from the video stream according to the respective skip intervals 33 in the frame skipping table 25. In FIG. 10, the region activity table 63 shows that for region ID #1, the activity detected therein increases from a value of ‘3’ to ‘10’ for successively sampled frame IDs #100 and #101 corresponding to frames 11 and 12 in FIG. 10. While the frames in the region activity table 136 have frame IDs #100 and #100 as shown in FIG. 10, these frames are actually separated in the video stream by an interval 13 corresponding to the current frame skip value 33 associated with Region ID #1 in the frame skipping table 25. The change from an activity value of 3 to 10 is detected as a change which is large enough to cause the skip interval value 33 for region ID#1 to be decreased. As shown in FIG. 10, the interval 13 between frames 12 and 14 is shortened, as is the interval between frames 14 and 15.

The change in the skip interval value 33 is fed back to the video frame allocator 5 for adjusting the assignments of frames to the Video frame region processors. Accordingly, the frame skip value can be dynamically adjusted based on current content and activity seen in the specific regions of the frames 11, 12, 14, 15 and the like of the video stream 2. In other words, the results of the feature extraction and activity tracker module 62 cause the values stored in the frame skipping table 25 to be modified which provides for faster yet accurate real-time processing of the video stream overall by selectively omitting intervals 13 of frames 9 rather than processing all of the frames 9 of the video streams in sequence.

After the feature extraction and activity tracker module 62 of the video frame region processors 6 has analyzed the region of a given frame, the extracted features are output to the video stream feature index 8 to facilitate searching for the video stream among a plurality of other processed video content.

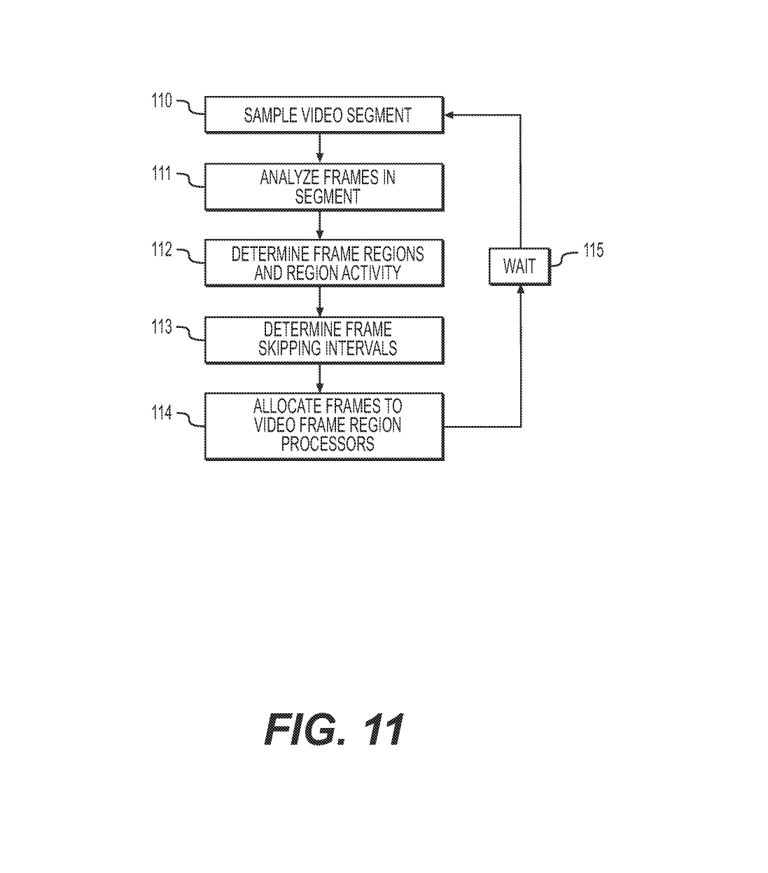

FIG. 11 illustrates an example process flow for determining frame skipping intervals and allocation of regions for processing according to some implementations. First at step 110, a video segment 10 is sampled from a received video stream 2 by the video segment analyzer 4 and stored in the video segment frame buffer 21. The video stream 2 may be received from content sources such as video cameras, file systems or other devices that output a video stream. The sampled video segment 10 includes a number of frames 9 which may be manually configured or dynamically configured by the video segment analyzer. At step 111, the segment is first analyzed by the video frame region detection module 22 to set regions in the frames of the video stream. Further, the feature extraction and activity tracker module 23 analyzes the regions to determine the region activity therein at step 112.

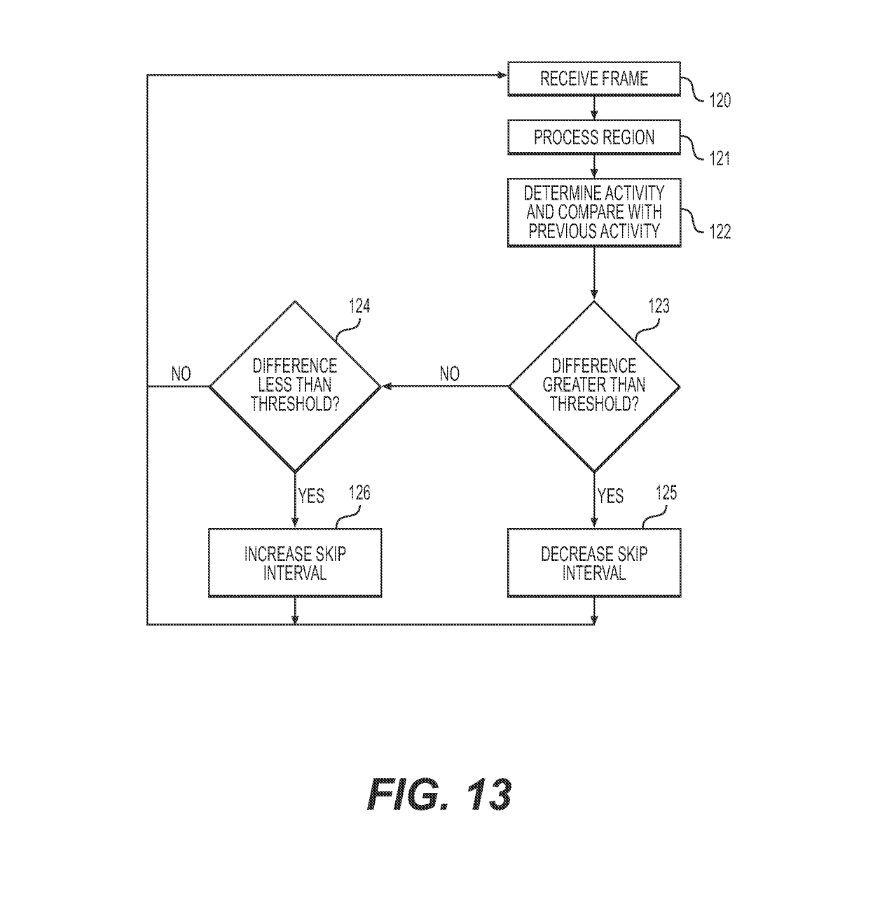

The video analysis at steps 111 and 112 includes applying image processing algorithms which are known in the art or may be developed in the future that have the ability to perform image feature vector extraction and comparison with a database of known features to identify the objects of interest in the regions. For example, facial recognition algorithms are applied to regions determined to contain faces in the video stream 2 and the detected faces are matched against a database of features of known persons to identify such persons in the video stream 2. Further, the video analysis at step 112 may also involve determining the motion of the objects or rate of change of shape, orientation or size of the objects in each region. Based on the video analysis at step 112, the frame skipping table 25 is generated for all the regions set for the video stream 2 at step 113 and stored in the frame skipping table 25. Next, at step 114, each region is allocated separately to the video frame region processors 6 by the video frame allocator 5. Each of the video frame region processors 6 independently apply image processing algorithms, which may be similar to those of the video segment analyzer 4, to extract image features defining faces, objects, shapes and textures from each assigned region. The processing performed by the video frame region processors 6 is explained in greater detail below and shown in FIG. 13. Further, in FIG. 11, at step 115 the video segment analyzer 4 will wait a predetermined period of time before resampling the video stream for a new segment to adjust the skip intervals 33 dynamically based on the current content of the sampled video segment 10. The wait period 115 may be determined manually or dynamically by the system based on the current content activity in the video stream 2. In some implementations, segments 10 may be periodically sampled from the video stream in the range of 15-45 seconds or the like.

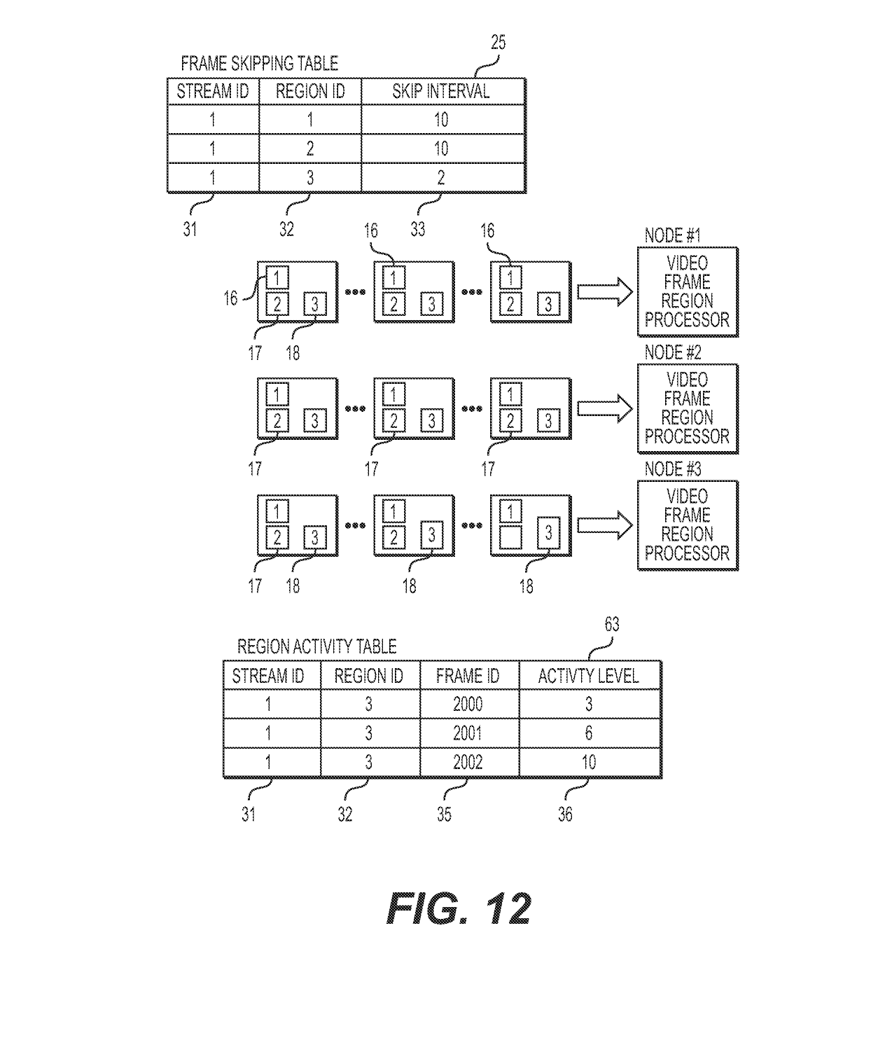

FIG. 12 illustrates an example of a detailed workflow for processing an exemplary video stream 2. In FIG. 12, it is assumed that the video segment analyzer 4 has sampled a segment 10 from the video stream 2 and set three regions 16, 17, 18 from the analysis of the segment 10. Further, in FIG. 12, the video frame allocator 5 assigns processing of three regions 16, 17, 18 separately to nodes #1 through #3 which are each video frame region processors 6. Specifically, node #1 is assigned to process the region 16, node #2 is assigned to process the region 17 and node #3 is assigned to process the region 18. For example, the region 16 may correspond to a face in the video stream, while the region 17 corresponds to a tree and the region 18 corresponds to a car. The video frame allocator 5 maintains the assignment of regions 16, 17, 18 to the nodes of the video processing cluster in the frame allocation table 43.

In some implementations, the video frame allocator 5 sends frames 9 of the video stream 2 to the video frame region processors 6 according to the frame skipping table 25 and the frame allocation table 43. In other implementations, the video frame region processors 6 may themselves sample the appropriate frames 9 from the video stream 2 according to the respective skip interval values 33 in the frame skipping table 25. As shown in FIG. 12, node #1 performs image processing on the region 16 for each of three successive frames which are sampled from the video stream 2 and separated by intervals 13 according to the corresponding entry in the frame skipping table 25. According to the analysis of each frame 9 by node #1, the region activity table 63 in the system memory thereof is updated to reflect the activity level of the region 16. Similarly, the region 17 is processed by node #2 in three successive frames of the video stream 2. The frames used by node #2 to analyze the region 236 may differ from the frames 9 used by node #1 depending upon whether the skip interval values 33 in the frame skipping table 25 are different. Likewise, node #3 processes the region 18 in three successive frames similarly to nodes #1 and #2.

However, in FIG. 12, the region 18 is shown to increase in size across the three frames processed by node #3. For example, if the region 18 includes a car therein, if the car increases in size relative to the overall frame size due to movement of the car relative to other objects in the frame 9, the region 18 is increased as well. Similarly, zooming in on the car would cause the region 18 to increase in size. In contrast, zooming out from the car would cause the region 18 to decrease in size. As would be understood by those of skill in the art, the regions set in the frames 9 may change in size contemporaneously throughout the video stream 2 and are not required to be static. The increase or decrease in region size of the region 18 is reflected in the region activity table 63 by the processing of node #3. In the region activity table 63, the change in the activity level for the region 18 is recorded. The region activity table 63 is updated each time a frame is analyzed by one of the video frame region processors 6. In turn, based on whether the activity levels 36 increase or decrease in the region activity table 63, the frame skipping table 25 will be updated accordingly. As a result, when the activity level 36 increases for a region, the associated skip interval 33 will decrease so the region will receive more frequent analysis due to the shortened interval 13 between selected frames 9. On the other hand, when the activity level 36 is decreased for a region, the skip interval 33 will increase so that the region is analyzed less frequently.

FIG. 13 illustrates an example region processing and frame skip interval updating flow according to some implementations for one of the video frame region processors 6. Each video frame region processor 6 which is assigned a region by the video frame allocator 5 will perform processing according to the flow shown in FIG. 13 according to some implementations. At step 120, for one region set by the video frame analyzer 4, a video frame 9 is received by one video frame region processor 6 that is taken from a respective video stream 2 according to the skip interval 33 set for the respective region by the video frame analyzer 4. At step 121, the feature extraction and activity tracker module 62 applies image processing to analyze the region of the frame 9. For example, feature extraction and matching with a database of known features may be performed at this time. Next, at step 122, activity of the region is determined through image processing to detect motion and changes in shape or orientation of the particular object in the region. The activity level 36 is recorded in the region activity table 63 for the region. At step 123, the change from the previously analyzed frame is compared with a threshold value. If the difference in the activity in the region is greater than the threshold value, then at step 125 the skip interval 33 is decreased in the frame skipping table 25. If the difference in the activity is not greater than the threshold value at step 123, than the flow continues to step 124 where it is determined if the difference in the activity is less than the threshold value. If the difference in the activity is less than the threshold value, then at step 126, the skip interval 33 is increased in the frame skipping table 25. Otherwise, at step 124, the skip interval value for the region is not modified and the flow returns to step 120 to process another frame.

Accordingly, the overall computational overhead for processing one or more video streams can be reduced by avoiding the need to process each of the frames in its entirety. In addition, not only is the processing of frames skipped according to the frame skipping table 25, but by applying image processing to individual regions (e.g., 16, 17, 18 in FIG. 10) which are determined to contain objects of interest for the selected frames (e.g., 11, 12, 14, 15), the computational overhead can be reduced further. As a result, different regions in the video stream 2 are processed at different rates according to the frame skipping table 25 so that the processing for each region can by dynamically tuned or otherwise adapted to the activity occurring therein across the selected frames rather than each consecutive frame. Therefore, annotating and indexing terms describing the content of the video stream can be accomplished in real-time with more efficient use of the available computing resources.

By performing analysis of each region independent of other regions and maintaining separate frame skipping values for each region, localized changes in activity in a particular region of the video stream will cause the frame skipping value in the particular region to decrease. Decreasing the frame skipping value 33 will cause the particular region to be analyzed in a larger number of frames due to the smaller sampling interval 13 associated with a decreased frame skipping interval value 33. Consequently, the rate at which sampling (e.g., the interval 13 between selected frames) of frames of other regions occurs can be determined separately from the localized activity in one particular region, and thereby prevent the overall computational overhead from increasing.

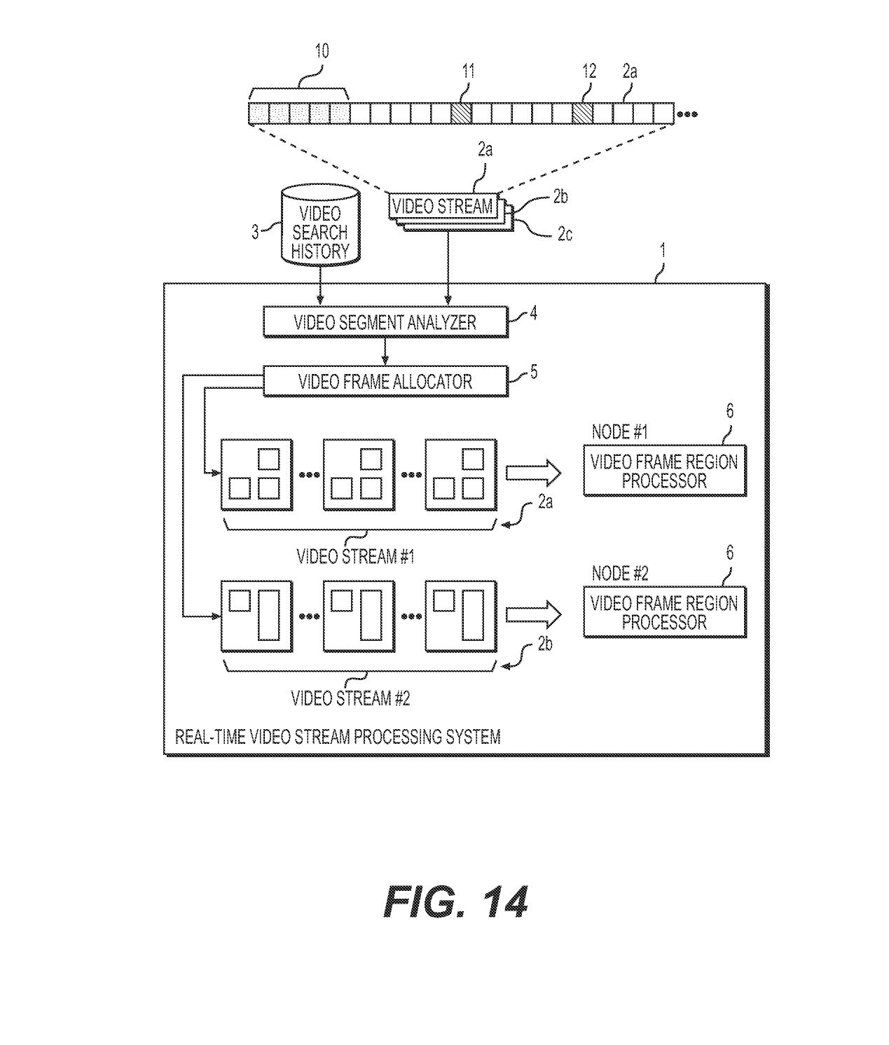

FIG. 14 illustrates an alternative workflow example for processing multiple video streams according to some implementations. In FIG. 14, two separate video streams 2a, 2b are received by the video segment analyzer 4. Each of the video streams have a respective segment sampled therefrom, and the video segment analyzer 4 analyzes each of the segments to set separate regions for each video stream. As in the previous implementations, image processing algorithms are applied to the segments 10 to extract image features like face, textures, shape and other useful features from objects present in the frames of the segments. Further to the analysis, the extracted features are compared with a video search history 3 to determine whether the extracted features match any of the search terms included in the video search history 3. The skip intervals 33 are individually associated with each of the regions in each of the video streams 2a, 2b and are set according to the results of matching with the video search history 3.

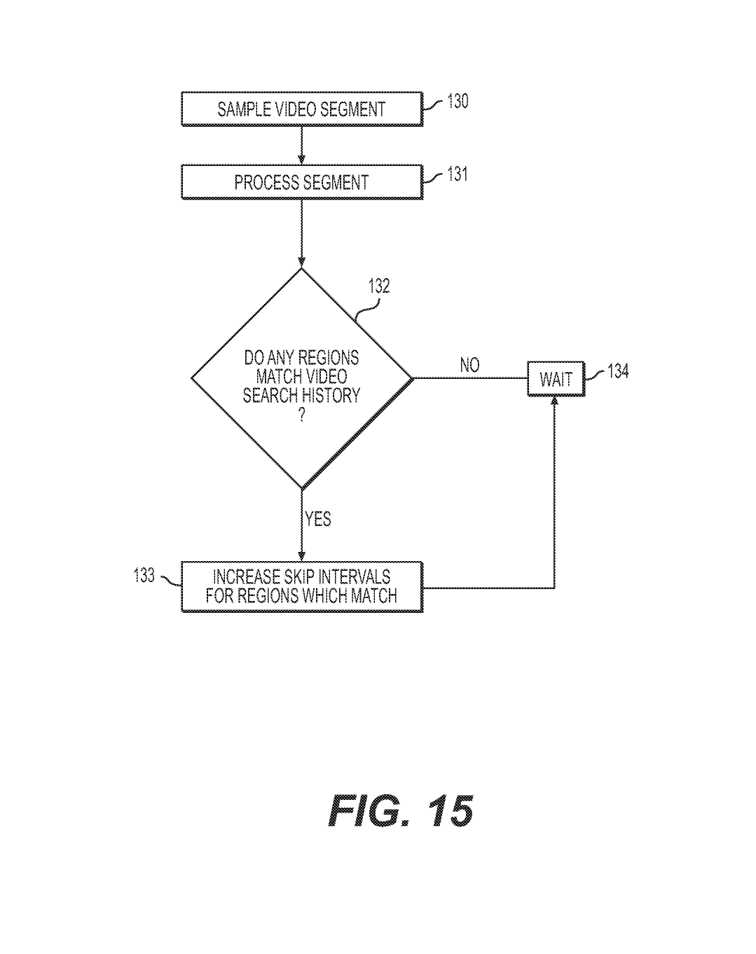

FIG. 15 illustrates an example workflow for determining frame skipping intervals using the video search history 3 according to some implementations. The video search history 3 includes recent search queries such as detailed information describing sporting events and movies based on popularity or frequency of searching. First at step 130, a video segment including a plurality of continuous frames is sampled from a video stream received by the video segment analyzer 4. Next, at step 131, the video segment is analyzed by region detection module 22 and the feature extraction and activity tracker module 23 of the video segment analyzer 4.

For a particular individual region, it is determined whether the extracted features of the object present therein matches any of the terms or contexts included in the video search history 3. If one or matches are found, the skip interval 33 for the region is increased above a default value and recorded in the appropriate entry in the frame skipping table 25 at step 133. Specifically, the increase in the skip interval 33 is based on the relative popularity or frequency of entries in the video search history 3. If a particular sporting event is a very popular search query and the particular region is found to match the sporting event, then a correspondingly large skip interval 33 may be set for the particular region. Likewise, if a relatively unpopular search query were to match the analysis of the particular region, the skip interval 33 may be increased by a correspondingly smaller amount. Further, the results of positive matches are stored in the video frame feature index 8 for the relevant video stream to facilitate searching for content contained in the video stream(s) 2. In these cases, the skip interval 33 is increased since less processing is needed on the region since appropriate terms or contexts in the region have been stored for the video stream 2 according to the present processing flow. At step 134, the video segment analyzer 4 waits for a predetermined time period before re-sampling the video stream for a new segment similarly to FIG. 11.

Returning to FIG. 14, once the skip intervals 33 have been set by the video segment analyzer 4, the video frame allocator 5 assigns individual video streams to individual video frame region processors 6. In FIG. 14, node #1 receives processing responsibilities for video stream 2 from the video frame allocator 5 while node #2 receives processing responsibilities for video stream 861. As a result, node #1 receives frames of a first video stream 2a according to the skip intervals 33 set for the regions of the first video stream 2a. Meanwhile, node #2 receives frames of a second video stream 2b according to the skip intervals 33 set for the regions of the second video stream 2b. Each of the regions is respectively processed by one of the nodes and the frame skipping table 25 is adjusted as in FIG. 13 similar to the other implementations described herein.

Depending on the separate activity levels in the regions of each of the video streams 2a, 2b, the processing load in each of node #1 and/or #2 may suffer. More specifically, if a relatively large number of regions are present in one video stream and/or experience large changes in activity levels in the regions, the skip intervals 33 for a majority of the regions may be caused to decrease. Such widespread decreasing of the frame skipping values, would cause a larger number of frames to be sampled due to the smaller intervals associated with each region. This problem is further compounded when multiple video streams are being concurrently processed in real time. In some instances, the processing efficiency may suffer. To compensate for the foregoing circumstances in which a large number of regions are set for a video stream or large amounts of activity are present therein, a resource allocator 7 as shown in FIG. 1 can provide additional computational resources to the individual video frame region processors 6.

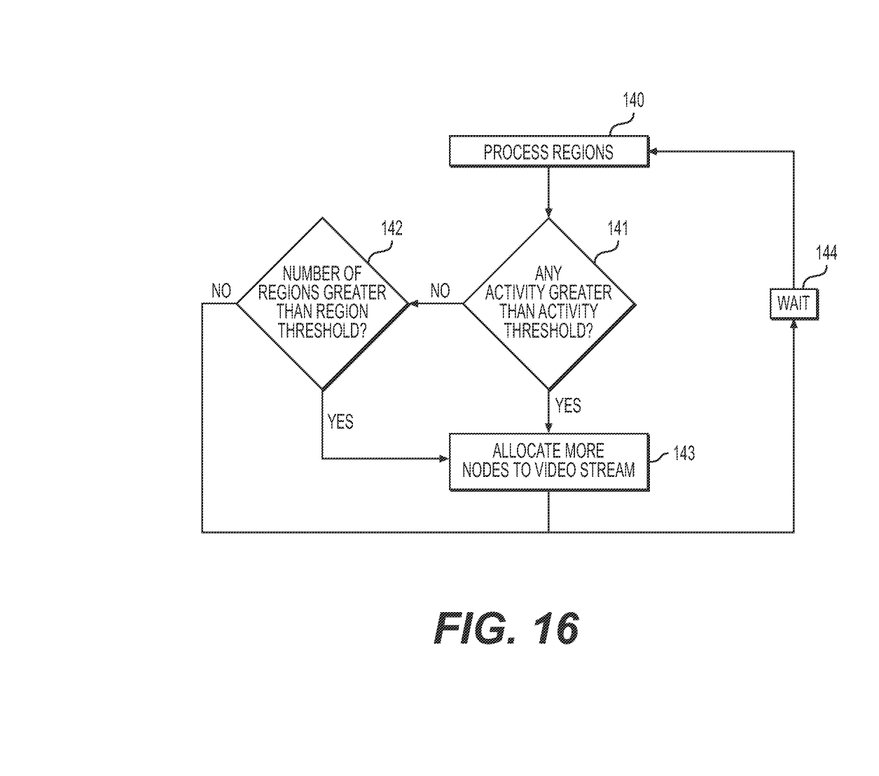

FIG. 16 illustrates an example resource allocation workflow according to some implementations. At step 140, regions are processed by the real-time video stream processing system in accordance with the procedures described herein and the activity levels 36 are obtained by the resource allocator 7 by referring to the region activity table 63 of each assigned video frame region processor 6 as stored in the frame allocation table 43 of the video frame allocator 5. At step 141, the resource allocator 7 considers whether any of the activity levels 36 in the frame region activity tables 63 exceed a predetermined activity threshold. For any regions having activity levels 36 exceeding the predetermined activity threshold, the resource allocator 7 causes more video frame region processors 6 to be allocated at step 143. More specifically, for a region with an activity level 36 exceeding the predetermined activity threshold, an additional video frame region processor 6 is assigned to analyze the region in conjunction with the previously assigned video frame region processor 6 as listed in the frame allocation table 43. Further, the frame allocation table 43 is updated to reflect the additional assignment of any further video frame region processor(s) 6.

At step 141, if the activity threshold is not exceeded, then the processing flow continues to step 142. Here, the resource allocator compares the number of regions set in the video stream with a predetermined region number threshold. For example, the number of regions set for a given video stream can be determined by referring to the frame skipping table 25 or the frame allocation table 43. As shown in FIG. 16, when the number of regions exceeds the predetermined region number threshold, one or more additional video frame region processors 6 are assigned to process the video stream. On the other hand, at step 142, if the predetermined region number threshold is not exceeded, no additional video frame region processors are assigned to the video stream at this time. Following steps 142 and 143, the flow pauses for a predetermined amount of time or otherwise waits for the frame region activity tables 63 of the allocated video frame region processors 6 to be updated at Step 144. After waiting at step 144, the processing flow returns to step 140.

While the implementations herein have been described in the context of systems, methods and processes, the present invention also relates to apparatuses for performing the operations herein. Various instructions, methods, and techniques described herein may be considered in the general context of computer-executable instructions, such as program modules stored on computer-readable media, and executed by the processor(s) herein. Generally, program modules include routines, programs, functions, objects, components, data structures, etc., for performing particular tasks or implementing particular abstract data types. These program modules, and the like, may be executed as native code or may be downloaded and executed, such as in a virtual machine or other just-in-time compilation execution environments. Typically, the functionality of the program modules may be combined or distributed as desired in various implementations. Any implementation of these modules and techniques may be stored, shared, or transmitted on storage media or communication media.

In the foregoing description, various implementations have been described with reference to numerous specific details that may vary from implementation to implementation. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative sense rather than a restrictive sense.

What is claimed is:

1. A video stream processing system, comprising:
a plurality of processors, including a first processor and a second processor; and
at least one memory connected with the processors and storing executable instructions which cause the processors to:
set a plurality of regions, including a first region and a second region, in a video stream;
set a plurality of frame skip values for the regions, including a first frame skip value for the first region and a second frame skip value for the second region, according to respective contexts thereof;
analyze each of the regions in a plurality of frames of the video stream with the processors, where the first region is analyzed by the first processor and the second region is analyzed by the second processor,
wherein the first processor analyzes the first region in a first frame of the video stream, selects a second frame of the video stream according to the first frame skip value, analyzes the first region in the second frame, and updates the first frame skip value based on activity in the first region, and
wherein the second processor analyzes the second region in a third frame of the video stream, selects a fourth frame of the video stream according to the second frame skip value, analyzes the second region in the fourth frame, and updates the second frame skip value based on activity in the second region.

2. The video stream processing system of claim 1, wherein the first frame skip value for the first region is set according to a first object therein, the second frame skip value for the second region is set according to a second object therein different from the first object, and the first frame skip value and the second frame skip value are different,
wherein the first processor analyzes the first object in the first region and the activity in the first region is based on analyzing the first object,
wherein the second processor analyzes the second object in the second region and the activity in the second region is based on analyzing the second object, and
wherein the activity is zooming or movement.

3. The video stream processing system of claim 1, wherein, when the activity in the first region is greater than an activity threshold, one or more additional processors are allocated to analyze the first region, and
wherein, when a number of the regions is greater than a region threshold, one or more additional processors are allocated to analyze the regions.

4. The video stream processing system of claim 1, wherein a third processor of the plurality of processors sets the plurality of regions, and each of the regions in the video stream, including the first region and the second region, are separately processed on different ones of the processors other than the third processor.

5. The video stream processing system of claim 1, wherein the first processor decreases the first frame skip value when the first processor detects that the activity from the first frame to the second frame is greater than a threshold,
wherein the first processor increases the first frame skip value when the first processor detects that the activity from the first frame to the second frame is less than the threshold,
wherein the second processor decreases the second frame skip value when the second processor detects that the activity from the third frame to the fourth frame is greater than the threshold, and
wherein the second processor increases the second frame skip value when the second processor detects that the activity from the third frame to the fourth frame is less than the threshold.

6. The video stream processing system of claim 1, wherein the at least one memory stores a search history, and
wherein, when setting the plurality of regions, the first region and the second region are analyzed to determine whether any objects that match the search history are present therein,
wherein, when an object matching the search history is present in the first region, the first frame skip value is increased prior to analyzing the first region by the first processor, and
wherein, when the object matching the search history is present in the second region, the second frame skip value is increased prior to analyzing the second region by the second processor.

7. The video stream processing system of claim 1, wherein the plurality of regions, including the first region and the second region, in the video stream are updated at a predetermined interval.

8. A computer implemented method for processing a video stream, comprising:
setting a plurality of regions, including a first region and a second region, in the video stream;
setting a plurality of frame skip values for the regions, including a first frame skip value for the first region and a second frame skip value for the second region, according to respective contexts thereof;
analyzing each of the regions in a plurality of frames of the video stream with a plurality of processors, including a first processor and a second processor, where the first region is analyzed by the first processor and the second region is analyzed by the second processor,
wherein the analyzing of the first region by the first processor includes:
analyzing the first region in a first frame of the video stream,
selecting a second frame of the video stream according to the first frame skip value,
analyzing the first region in the second frame, and
updating the first frame skip value based on activity in the first region, and wherein the analyzing of the second region by the second processor includes:
analyzing the second region in a third frame of the video stream,
selecting a fourth frame of the video stream according to the second frame skip value,
analyzing the second region in the fourth frame, and
updating the second frame skip value based on activity in the second region.

9. The method of claim 8, wherein the first frame skip value for the first region is set according to a first object therein, the second frame skip value for the second region is set according to a second object therein different from the first object, and the first frame skip value and the second frame skip value are different,
wherein the first processor analyzes the first object in the first region and the activity in the first region is based on analyzing the first object,
wherein the second processor analyzes the second object in the second region and the activity in the second region is based on analyzing the second object, and
wherein the activity is zooming or movement.

10. The method of claim 8, further comprising:
when the activity in the first region is greater than an activity threshold, allocating one or more additional processors to analyze the first region; and
when a number of the regions is greater than a region threshold, allocating one or more additional processors to analyze the regions.

11. The method of claim 8, wherein a third processor of the plurality of processors sets the plurality of regions, and each of the regions in the video stream, including the first region and the second region, are separately processed on different ones of the processors other than the third processor.

12. The method of claim 8, further comprising:
detecting that the activity from the first frame to the second frame is greater than a threshold and decreasing the first frame skip value by the first processor;
detecting that the activity from the first frame to the second frame is less than the threshold and increasing the first frame skip value by the first processor;
detecting that the activity from the third frame to the fourth frame is greater than the threshold and decreasing the second frame skip value by the second processor; and
detecting that the activity from the third frame to the fourth frame is less than the threshold and increasing the second frame skip value by the second processor.

13. The method of claim 8, further comprising:
determining whether any objects that match a search history are present in the plurality of regions prior to setting the plurality of frame skip values;
when an object matching the search history is present in the first region, increasing the first frame skip value prior to analyzing the first region by the first processor; and
when the object matching the search history is present in the second region, increasing the second frame skip value prior to analyzing the second region by the second processor.

14. The method of claim 8, further comprising:
updating the plurality of regions, including the first region and the second region, in the video stream at a predetermined interval.

15. One or more non-transitory computer-readable media encoded with instructions that, when executed on a plurality of processors, including a first processor and a second processor, instruct the processors to perform acts comprising:
setting a plurality of regions, including a first region and a second region, in a video stream;
setting a plurality of frame skip values for the regions, including a first frame skip value for the first region and a second frame skip value for the second region, according to respective contexts thereof;
analyzing each of the regions in a plurality of frames of the video stream with the plurality of processors, including the first processor and the second processor, where the first region is analyzed by the first processor and the second region is analyzed by the second processor,
wherein the analyzing of the first region by the first processor includes:
analyzing the first region in a first frame of the video stream,
selecting a second frame of the video stream according to the first frame skip value,
analyzing the first region in the second frame, and
updating the first frame skip value based on activity in the first region, and wherein the analyzing of the second region by the second processor includes:
analyzing the second region in a third frame of the video stream,
selecting a fourth frame of the video stream according to the second frame skip value,
analyzing the second region in the fourth frame, and updating the second frame skip value based on activity in the second region.

16. The one or more non-transitory computer-readable media of claim 15, wherein the first frame skip value for the first region is set according to a first object therein, the second frame skip value for the second region is set according to a second object therein different from the first object, and the first frame skip value and the second frame skip value are different,
wherein the first processor analyzes the first object in the first region and the activity in the first region is based on analyzing the first object,
wherein the second processor analyzes the second object in the second region and the activity in the second region is based on analyzing the second object, and
wherein the activity is zooming or movement.

17. The one or more non-transitory computer-readable media of claim 15, the acts further comprising:
when the activity in the first region is greater than an activity threshold, allocating one or more additional processors to analyze the first region; and
when a number of the regions is greater than a region threshold, allocating one or more additional processors to analyze the regions.

18. The one or more non-transitory computer-readable media of claim 15, wherein the plurality of regions are set by a third processor of the plurality of processors, and each of the regions in the video stream, including the first region and the second region, are separately processed on different ones of the processors other than the third processor.

19. The one or more non-transitory computer-readable media of claim 15, the acts further comprising:
detecting that the activity from the first frame to the second frame is greater than a threshold and decreasing the first frame skip value by the first processor;
detecting that the activity from the first frame to the second frame is less than the threshold and increasing the first frame skip value by the first processor;
detecting that the activity from the third frame to the fourth frame is greater than the threshold and decreasing the second frame skip value by the second processor; and
detecting that the activity from the third frame to the fourth frame is less than the threshold and increasing the second frame skip value by the second processor.

20. The one or more non-transitory computer-readable media of claim 15, the acts further comprising:
determining whether any objects that match a search history are present in the plurality of regions prior to setting the plurality of frame skip values;
when an object matching the search history is present in the first region, increasing the first frame skip value prior to analyzing the first region by the first processor; and
when the object matching the search history is present in the second region, increasing the second frame skip value prior to analyzing the second region by the second processor.
